(19) United States
(12) Patent Application Publication
(10) Pub. No.: US 2025/0379801 A1
(43) Pub. Date: Dec. 11, 2025

(54) MANAGING ARTIFICIAL INTELLIGENCE MACHINE LEARNING ENABLEMENT SERVICE

(71) Applicant: Lenovo (United States) Inc., Morrisville, NC (US)

(72) Inventor: Roozbeh ATARIUS, La Jolla, CA (US)

(21) Appl. No.: 19/300,348

(22) Filed: Aug. 14, 2025

(51) Int. Cl. H04L 41/16; H04L 5/00; H04L 67/02

(52) U.S. Cl. CPC H04L 41/16; H04L 5/0053; H04L 67/02

(57) ABSTRACT

Various aspects of the present disclosure relate to a User Equipment (UE) configured to or operable to receive, from a network entity, a request for an Artificial Intelligence Machine Learning Enablement (AIMLE) client participation service, wherein the request comprises a first format or a second format, wherein the first format comprises a Notification associated with a subscription event comprising information for the AIMLE client participation service, and wherein the second format comprises custom request comprising information for the AIMLE client participation service, and wherein the request comprises an indication for the UE to verify participation in one or more AI/ML operations associated with the AIMLE client participation service, and transmit, to the network entity, a response for the AIMLE client participation service, wherein the response includes a positive acknowledgment or a negative acknowledgment for the participation in the one or more AI/ML operations associated with the AIMLE client participation service.

### TECHNICAL FIELD

The present disclosure relates to wireless communications, and more specifically to participation in Artificial Intelligence Machine Learning Enablement (AIMLE) operations.

### BACKGROUND

A wireless communications system may include one or multiple network communication devices, otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive, from a network entity, a request for an AIMLE client participation service, wherein the request comprises a first format or a second format, wherein the first format comprises a Notification associated with a subscription event comprising information for the AIMLE client participation service, and wherein the second format comprises custom request comprising information for the AIMLE client participation service, and wherein the request comprises an indication for the UE to verify participation in one or more AI/ML operations associated with the AIMLE client participation service, and transmit, to the network entity, a response for the AIMLE client participation service, wherein the response includes a positive acknowledgment or a negative acknowledgment for the participation in the one or more AI/ML operations associated with the AIMLE client participation service.

A processor (e.g., a standalone processor chipset, or a component of a UE) for wireless communication is described. The processor may be configured to, capable of, or operable to perform one or more operations as described herein. For example, the processor may be configured to, capable of, or operable to receive, from a network entity, a request for an AIMLE client participation service, wherein the request comprises a first format or a second format, wherein the first format comprises a Notification associated with a subscription event comprising information for the AIMLE client participation service, and wherein the second format comprises custom request comprising information for the AIMLE client participation service, and wherein the request comprises an indication for the

UE to verify participation in one or more AI/ML operations associated with the AIMLE client participation service, and transmit, to the network entity, a response for the AIMLE client participation service, wherein the response includes a positive acknowledgment or a negative acknowledgment for the participation in the one or more AI/ML operations associated with the AIMLE client participation service.

A method performed or performable by a UE for wireless communication is described. The method may include receiving, from a network entity, a request for an AIMLE client participation service, wherein the request comprises a first format or a second format, wherein the first format comprises a Notification associated with a subscription event comprising information for the AIMLE client participation service, and wherein the second format comprises custom request comprising information for the AIMLE client participation service, and wherein the request comprises an indication for the UE to verify participation in one or more AI/ML operations associated with the AIMLE client participation service, and transmitting, to the network entity, a response for the AIMLE client participation service, wherein the response includes a positive acknowledgment or a negative acknowledgment for the participation in the one or more AI/ML operations associated with the AIMLE client participation service.

An NE (e.g., a base station) for wireless communication is described. The NE may be configured to, capable of, or operable to perform one or more operations as described herein. For example, the NE may be configured to, capable of, or operable to transmit, to a UE, a request for an AIMLE client participation service, wherein the request comprises a first format or a second format, wherein the first format comprises a Notification associated with a subscription event comprising information for the AIMLE client participation service, and wherein the second format comprises custom request comprising information for the AIMLE client participation service, and wherein the request comprises an indication for the UE to verify participation in one or more AI/ML operations associated with the AIMLE client participation service, and receive, from the UE, a response for the AIMLE client participation service, wherein the response includes a positive acknowledgment or a negative acknowledgment for the participation in the one or more AI/ML operations associated with the AIMLE client participation service.

A processor (e.g., a standalone processor chipset, or a component of a NE) for wireless communication is described. The processor may be configured to, capable of, or operable to perform one or more operations as described herein. For example, the processor may be configured to, capable of, or operable to transmit, to a UE, a request for an AIMLE client participation service, wherein the request comprises a first format or a second format, wherein the first format comprises a Notification associated with a subscription event comprising information for the AIMLE client participation service, and wherein the second format comprises custom request comprising information for the AIMLE client participation service, and wherein the request comprises an indication for the UE to verify participation in one or more AI/ML operations associated with the AIMLE client participation service, and receive, from the UE, a response for the AIMLE client participation service, wherein the response includes a positive acknowledgment or a negative acknowledgment for the participation in the one or more AI/ML operations associated with the AIMLE client participation service.

A method performed or performable by a NE for wireless communication is described. The method may include transmitting, to a UE, a request for an AIMLE client participation service, wherein the request comprises a first format or a second format, wherein the first format comprises a Notification associated with a subscription event comprising information for the AIMLE client participation service, and wherein the second format comprises custom request comprising information for the AIMLE client participation service, and wherein the request comprises an indication for the UE to verify participation in one or more AI/ML operations associated with the AIMLE client participation service, and receiving, from the UE, a response for the AIMLE client participation service, wherein the response includes a positive acknowledgment or a negative acknowledgment for the participation in the one or more AI/ML operations associated with the AIMLE client participation service.

### BRIEF DESCRIPTION OF THE DRAWINGS

FIG. 1 illustrates an example of a wireless communications system in accordance with aspects of the present disclosure.

FIG. 2 illustrates an example of a signaling diagram in accordance with aspects of the present disclosure.

FIG. 3 illustrates an example of a resource Uniform Resource Identifier (URI) structure for an Application Programming Interface (API) in accordance with aspects of the present disclosure.

FIG. 4 illustrates an example of structured data types that may be used in a request message in accordance with aspects of the present disclosure.

FIG. 5 illustrates an example of a resource URI structure for an API in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a NE in accordance with aspects of the present disclosure.

FIG. 9 illustrates a flowchart of method performed by a UE in accordance with aspects of the present disclosure.

FIG. 10 illustrates a flowchart of method performed by a NE in accordance with aspects of the present disclosure.

### DETAILED DESCRIPTION

In some wireless communication systems, data analytics may provide network operators with capabilities to improve services by predicting events associated with network behaviour, network slice performance, etc. In some cases, AIML services may be particularly well suited to perform such data analytics. The AIML services may be implemented, for example, by a Network Data Analytics Function (NWDAF), which may be configured to collect analytics information from, and distribute analytics information, to various network entities (e.g., core network entities) within the wireless communication systems. Additionally, AIML services supported by the NWDAF may further be configured to support network operators by enabling efficient AIML model distribution, AIML model transfer, and/or AIML model training for various applications. Such applications may include, but is not limited to, video recognition, speech recognition, robotic control, driving assistance, among others.

An AIML enablement (AIMLE) service may enable an AMILE server to perform one or more AIML operations using one or more specified ML models. However, there are no existing protocols for managing participation of UEs in AIML operations. Accordingly, the present disclosure provides implementations of protocols for managing participation of UEs in operations of an AIMLE service.

For example, implementations include transmitting a request for an Artificial Intelligence Machine Learning Enablement (AIMLE) client participation service from a network entity to a UE. The request may have a first format with a Notification associated with a subscription event comprising information for the AIMLE client participation service, or a second format that is a custom format. These formats provide efficient solutions for AIMLE client participation service requests.

Aspects of the present disclosure are described in the context of a wireless communications system.

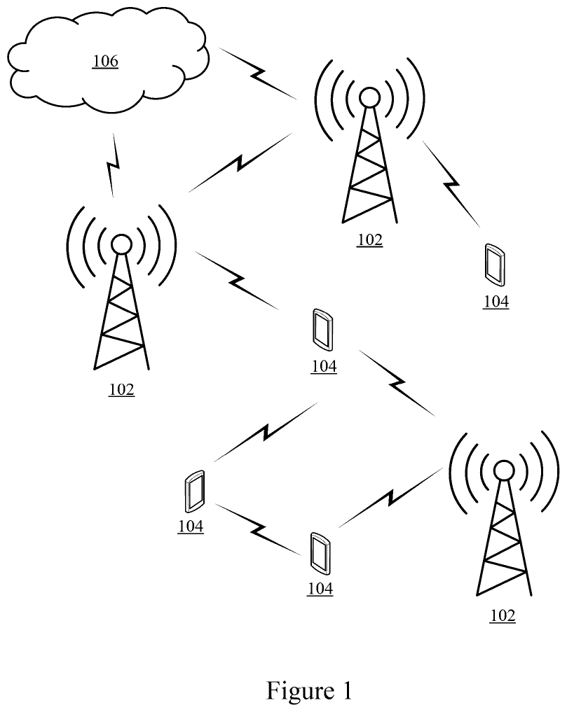

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a

communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FRI may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As illustrated in FIG. 1, a UE 104 may receive, from a NE 102, a request for an Artificial Intelligence Machine Learning Enablement (AIMLE) client participation service, wherein the request comprises a first format or a second format, wherein the first format comprises a Notification associated with a subscription event comprising information for the AIMLE client participation service, and wherein the second format comprises custom request comprising information for the AIMLE client participation service, and wherein the request comprises an indication for the UE to verify participation in one or more AI/ML operations associated with the AIMLE client participation service. The UE 104 may transmit, to the NE 102, a response for the AIMLE client participation service, wherein the response includes a positive acknowledgment or a negative acknowledgment for the participation in the one or more AI/ML operations associated with the AIMLE client participation service.

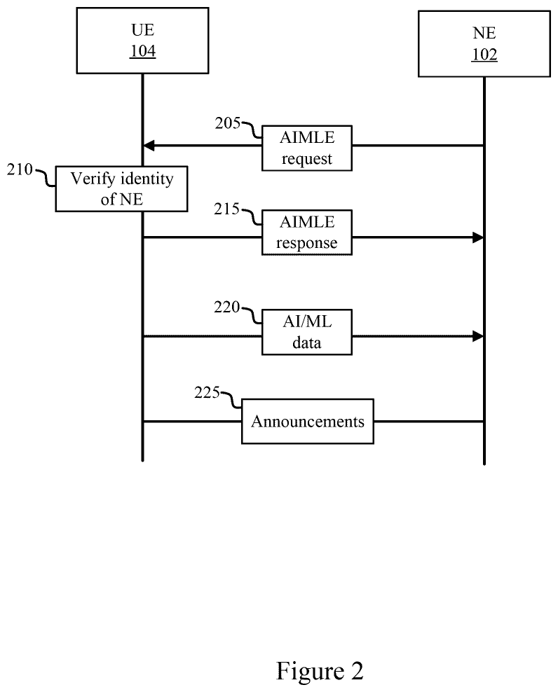

FIG. 2 illustrates an example of a signaling diagram in accordance with aspects of the present disclosure. In some examples, the signaling diagram implements or is implemented by aspects of the wireless communications system 100. The signaling diagram may implement or be implemented by one or more devices, such as an NE 102 and a UE 104, which may be examples of an NE 102 and a UE 104 as described with reference to FIG. 1. The signaling diagram may illustrate an example of an AIMLE-related procedure between the NE 102 and the UE 104. Alternative examples of the following may be implemented, where some processes are performed in a different order than described or are not performed. In some cases, processes may include additional features not mentioned below, or further processes may be added.

Each of one or more of the NE 102 and the UE 104 may be configured with a protocol stack including various functional layers. For example, the protocol stack may include, but is not limited to, a physical (PHY) layer configured to perform modulation, coding, and transmission of data over a physical radio channel; a medium access control (MAC) layer configured to perform scheduling, multiplexing, and error correction; a radio link control (RLC) layer configured to provide segmentation, reassembly, and retransmission of data; and a packet data convergence protocol (PDCP) layer configured to perform header compression, ciphering, and integrity protection. In some examples, higher-layer protocols may include a radio resource control (RRC) layer configured to manage radio bearers and mobility, and a non-access stratum (NAS) layer configured to handle core network signaling, session management, and mobility management. Above these layers, an application (APP) layer may be present, which can execute end-user or network applications and may interface with service and application frameworks. The APP layer may carry, for example, services, AI/ML-enabled network analytics, vertical-industry applications, etc.

In the example of FIG. 2, the NE 102 may be implemented as an AIMLE server or as a base station (e.g., gNB) in communication with the AIMLE server. In some examples, the NE 102 may be a server coupled with (e.g., operatively, communicatively, functionally, electronically, electrically) a CN 106, and configured to transmit a request 205 (also referred to as an AIMLE request as shown in FIG. 2) via an APP layer of the server. In other examples, the NE 102 may be a base station configured to transmit the request 205 via a PHY layer of the base station.

The UE 104 may be implemented as an AIMLE client, or an entity that is a client of a set of AIMLE operations of an AIMLE server, or as a prospective AIMLE client. In some implementations, the request 205 may include a request for the UE 104 to participate (e.g., join) or cease participation (e.g., depart) in one or more AIMLE operations that form a subset of a set of AIMLE operations associated with an AIMLE service. By way of example, if an AIMLE service is associated with ten (10) different operations, the request 205 may specify that the UE 104 participate in one, two, three, or five of those operations.

According to one implementation, the request 205 may be a notification associated with Service Enabler Architecture Layer (SEAL) group management. In some examples, the SEAL group management notification may be based on an assumption that the UE 104 has an event subscription to an AIMLE server (e.g., the NE 102). In such examples, the NE 102 may transmit (e.g., notify, send) the notification to the UE 104 for purposes of an AIMLE client participation service. The AIML client participation service may enable the NE 102 to request the UE 104 to join (e.g., subscribe to, initiate participation in) or depart (e.g., unsubscribe from, terminate participation in) one or more AIML operations, as defined in 3GPP Technical Specification (TS) 23.482 “Functional architecture and information flows for AIML Enablement Service,” V19.2.0 (2025-06), is incorporated by reference herein in its entirety.

In some implementations, a service operation for an Aimlec_AIMLEClientParticipation API may be referenced as Aimlec_AIMLEClientParticipation_Request. This service operation may be invoked by the NE 102 to request participation of the UE 104 in one or more AIML operations. In some examples, an Aimlec_FLGroupIndication_Request service operation may be invoked by the NE 102 to request that the UE 104 join (e.g., subscribe to) or depart (e.g., unsubscribe from) one or more AIML operations as an AIMLE client. These service operation names are provided for purposes of example and description, and are not intended to be limiting. In some other examples, the API and associated service operations may be identified by different names while providing similar or the same functionality.

The subscription may be referred to as a pseudo-operation, as the subscription may be limited to a subset of events associated with a full (e.g., complete) AIMLE service. In other words, the request 205 may not constitute a conventional request to subscribe to the full AIMLE service. According to one implementation, a notification URI may be provided during creation of a subscription for the SEAL group management, as described in clause A.1.2 of 3GPP TS 24.544 “Group Management-Service Enabler Architecture Layer for Verticals (SEAL),” V18.5.1 (2025-07), incorporated by reference herein in its entirety.

The request 205 may be a Hypertext Transfer Protocol (HTTP) POST request. In some examples, to request the UE 104 to join or depart one or more AIML operations, the NE 102 may transmit an HTTP POST message to the UE 104 with a request URI set to “{notifUri}” and a payload (e.g., body) of the request may include an AimlecParticipationReq data structure, as described in more detail below.

At 210, in response to the received request 205 (e.g., an HTTP POST request), the UE 104 may verify (e.g., validate, confirm) the identity of the NE 102 and determine whether the NE 102 is authorized to request the UE 104 to participate in AIML operations.

The UE 104 may transmit a response 215 (also referred to as an AIMLE

response as shown in FIG. 2) in response to and/or based at least in part on the received request 205 and/or the verified identity of the NE 102. The response 215 may indicate an agreement (e.g., acknowledgement, acceptance) or denial (e.g., negative acknowledgment, rejection) of the request 205. If the NE 102 is determined to be an unauthorized to request the UE 104 to participate in AIML operations, the UE 104 may respond to the NE 102 with an error cause (e.g., error code) in the response 215. Otherwise, if the NE 102 is determined to be authorized to request the UE 104 to participate in AIML operations, the UE 104 may transmit the response 215 to the NE 102 with an HTTP “200 OK” status code, with the payload (e.g., body) of the response 215 including a AimlecParticipationResp data structure as described in more detail below. Alternatively, if the request 205 (e.g., HTTP POST request) is not handled successfully, the UE 104 may transmit the response 215 with an error cause (e.g., error code) as described in more detail below.

In some examples, when the request 205 is a request for the UE 104 to participate in AIML operations, and the UE 104 accepts the request and indicates the acceptance via the response 215 to the NE 102, the UE 104 may transmit data 220 collected in support of the AIML operations. Additionally, or alternatively, the NE 102 may transmit one or more announcements 225 associated with the AIML subscription events in which the UE 104 is participating. Examples of the announcements 225 may include, but is not limited to, identity (e.g. identifiers, identification information) of clients to be added or removed from an AIMLE client set, one or more parameters for AIML training operations, schedule information, etc.

In some implementations, the AIMLE client participation service may use the Aimlec_AIMLEClientParticipation API. The API URI of the Aimlec_AIMLEClientParticipation API may be: {apiRoot}/<apiName>/<apiVersion>.

In some implementations, the request 205 is an HTTP request with one or more URI. For example, some implementations may have the resource URI structure: {apiRoot}/<apiName>/<apiVersion>/<apiSpecificSuffixes>with one or more of the following components, for example: the {apiRoot} may be set as described in clause 5.2.4 of 3GPP TS 29.122, “T8 reference point for Northbound APIs”, V19.3.0 (2025-06), incorporated herein by reference in its entirety; the <apiName>may be “aimlec-cp”; the <apiVersion>may be “v1” (or a later version as appropriate).

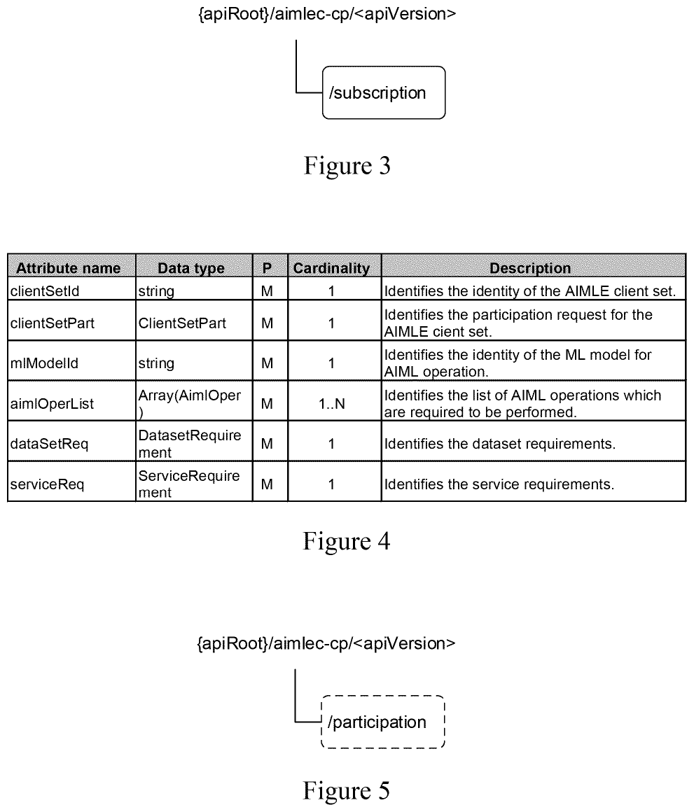

FIG. 3 illustrates an example of attributes of a resource URI structure for a Aimlec_AIMLEClientParticipation API in accordance with aspects of the present disclosure. As seen in the figure, the resource URI may be a/subscription URI. In particular, the resource URI may have the following structure: {apiRoot}/aimlec-cp/<apiVersion>/subscription. The subscription may be for a pseudo resource, e.g., a portion of a total set of resources associated with an AIMLE service.

In some implementations, HTTP error status codes of 3GPP TS 29.122 V19.3.0 may apply to a HTTP POST message exchange.

Notifications of the request 205 may be comprised in a URI {notifUri} of an HTTP POST notification. The notifications may include one or more notifications associated with AIMLE client participation for one or more AIML operations. For example, the notifications in the URI may indicate one or more AIML operations in which the UE 104 participates in. The notifications may comprise parameters of the operations indicated by the request 205, such as resources (e.g., time and frequency resources) associated with the operations, frequency of measurements for the operations, types of measurements for the operations (e.g., RSSI or SINR measurements), etc. In some implementations, notifications may comply with clause 5.2.5 of 3GPP TS 29.122 V19.3.0.

In some implementations, the value of {notifURI} may be set to the value of the Callback-URI parameter that is provided during creating subscription for the SEAL group management, as specified in clause A.1.2 of 3GPP TS 24.544 V18.5.1.

An AIMLE client participation notification may be used by the NE 102 to request the AIMLE client (e.g., UE 104) that has subscribed to such notifications, to participate in one or more AIML operations.

Data structures supported by a POST request payload (e.g., body) of a request 205 may include an AimlecParticipationReq data type, with a cardinality of 1. The AimlecParticipationReq data type may be a notification of a request for participation in one or more AIML operations.

The response 215 transmitted by the UE 104 may include an acknowledgement of the request 205. The acknowledgement may be a positive or negative acknowledgement indication for the participation in the one or more AI/ML operations associated with the AIMLE client participation service.

In some implementations, a positive acknowledgement may have a data type of AimlecParticipationResp, and may comprise a response code 200 which indicates that the NE 104 will participate in the AIML operations provided in the associated request 205.

The response 215 may comprise a 307 temporary redirect response code. In such an implementation, the response 215 may include a Location header field containing an alternative URI of a resource located in an alternative AIMLE client. Redirection handling may be handled as described in clause 5.2.10 of 3GPP TS 29.122 V19.3.0.

The response 215 may comprise a 308 permanent redirect response code. In such an implementation, the response 215 may include a Location header field containing an alternative URI of the resource located in an alternative AIMLE client.

When the response 215 is not successfully received by the UE 104, the response 215 may indicate an HTTP error status code for the HTTP POST method listed in table 5.2.6-1 of 3GPP TS 29.122 V19.3.0.

Data types of the Aimlec_AIMLEClientParticipation API may include one or more of the following data types: AimlecParticipationReq, which represents the participation request for the AIML operations; AimlecParticipationResp, which represents the participation response for the AIML operations, AimlOper, which represents the participation type, and ClienSetPart, which represents the participation request for the AIMLE client set.

In some implementations, data types may re-used by the Aimlec_AIMLEClientParticipation API from other specifications, including a reference to their respective specifications, and when needed, a short description of their use within the Aimlec_AIMLEClientParticipation API. For example, the API may use DatasetRequirement and/or ServiceRequirement as specified in 3GPP TS 29.482 V19.2.0 to represents dataset requirements, and ScheduledCommunicationTime as specified in 3GPP TS 29.122 V19.3.0 to represent an offered scheduled communication time.

FIG. 4 illustrates an example of structured data types that may be present in a request 205 in accordance with aspects of the present disclosure. Implementations may include one or more of the structured data types identified in FIG. 4 to provide information about the AIMLE client participation services which the NE 102 is requesting the UE 104 to participate in.

In some implementations, the information for the AIMLE client participation service in request 205 includes the at least one operation, at least one schedule, and an indication for adding or removing the UE 104 from the client set. In some implementations, the information for the AIMLE client participation service in request 205 includes at least one dataset requirement for the at least one operation, an identifier of the network entity, an identifier for the AIMLE client set, an identifier of a machine learning (ML) model associated with the at least one operation, and at least one service requirement of the client participation service.

The AimlecParticipationResp data structure of response 215 may include a Boolean value corresponding to a positive or negative acknowledgement of the request 205. The Boolean value may be a “true” value which indicates the willingness of the UE 104 to be added to or to be removed from the AIML client list to perform AIML operations, or a “false” value which indicates the denial of the UE 104 to be added to or to be removed from the AIML client list to perform AIML operations.

As noted above, data types of the Aimlec_AIMLEClientParticipation API may include AimlOper, which represents the participation type. In such an implementation, the AimlOper data type may comprise an aimlOperId string which identifies an AIML operation. In addition, the AimlOper data type may further comprise an aimlOperSched with a attributScheduledCommunicationTime data type having a cardinality of 0 . . . 1 which identifies a schedule for an AIML operation. Accordingly, in some implementations, the request 205 may identify AIML operations for which the UE 104 is requested to join, and may also indicate the schedule of those AIML operations.

The ClientSetPart attribute of FIG. 4 may represent a participation request for the AIMLE client set. In particular, the ClientSetPart attribute may indicate whether the request 205 is a request to join or depart from an AIMLE client set associated with one or more AIML operations. Accordingly, the request 205 may be a request for the UE 104 to cease participating in one or more AIML operations which are specified by the request.

Error handling may be implemented for the Aimlec_AIMLEClientParticipation API using HTTP error responses as specified in clause 5.2.6 of 3GPP TS 29.122 V19.3.0. Protocol errors and application errors specified in clause 5.2.6 of 3GPP TS 29.122 V19.3.0 may be supported by the API, and security aspects of the API may be implemented according to the provisions of clause 6 of 3GPP TS 29.122 V19.3.0.

In a second implementation, the NE 102 uses a custom operation to request the UE 104 to participate in operations of the AIMLE client participation service. The custom operation may include transmitting a request 205 (e.g., a request message) with an HTTP POST format that is customized for the purpose of requesting a UE 104 to participate or cease participation in one or more AIML operations associated with an AIMLE client participation service. In the second implementation, while the request 205 is transmitted outside the SEAL group management context, other aspects of the request 205 may be the same or similar to those described above with respect to the first implementation. Accordingly, the following description may omit certain details of the request 205 that overlap with the features discussed above with respect to the first implementation.

The second implementation may include the same or similar transmissions shown in FIG. 2 as the first implementation. For example, the second implementation may include an NE 102 transmitting an AIMLE request 205 to a UE 104 which requests the UE 104 to join or depart from a subset of a set of AIML operations associated with an AIMLE client participation service. The UE 104 may verify the identity of the NE 102 that transmitted the request 205, and upon successful verification, transmit a response 215 (e.g., a response message) to the NE 102. The response 215 may be a positive or negative acknowledgement, otherwise characterized as an agreement or a denial of the participation request of request 205. Subsequently, when the request 205 is a request to participate in AIML operations and the UE 104 accepts the request in a response 215, the UE 104 may transmit data 220 collected in support of the AIML operations and receive announcements 225 associated with the AIML operations.

In the second implementation, an NE 102 may use a service operation which may be named Aimlec_FLGroupIndication_Request to request the UE 104 to join or depart one or more AIML operations as an AIMLE client.

To request a UE 104 to join or depart one or more AIML operations, the NE 102 may transmit an HTTP POST request 205 (custom operation: “Participation for AIML operations”) with a Request-URI set to “{apiRoot}/aimlec-cp/<apiVersion>/participation” and the request payload (e.g., body) including the AimlecParticipationReq data structure discussed above with respect to the first implementation.

At 210, after receiving the HTTP POST request from the NE 102, the UE 104 may verify the identity of the NE 102 and determine whether the NE 102 is authorized to request the UE 104 to participate in AIML operations.

The UE 104 may transmit a response 215 to the AIMLE request indicating an agreement or denial of the request. For example, if the UE 104 determines the NE 102 is not authorized at 210, the UE 104 may respond to the NE 102 with an error cause (e.g., error code) in the response 215.

Otherwise, if the NE 102 is authorized, the UE 104 may transmit a response 215 to the NE 102 with an HTTP 200 (“OK”) status code with a response payload (e.g., body) including the AimlecParticipationResp data structure as discussed above if the HTTP POST request is handled successfully. Alternatively, if the HTTP POST request 205 is not handled successfully, UE 104 may send a response 215 with an error cause (e.g., error code).

The AIMLE client participation service of the second implementation may use an AIMLEClientParticipation API with the same or similar characteristics as that of the first implementation. For example, the API URI of the Aimlec_AIMLEClientParticipation API may be: {apiRoot}/<apiName>/<apiVersion>.

In some implementations, the request 205 is an HTTP request with one or more URI. For example, some implementations may have the resource URI structure: {apiRoot}/<apiName>/<apiVersion>/<apiSpecificSuffixes>with one or more of the following components, for example: the {apiRoot} may be set as described in clause 5.2.4 of 3GPP TS 29.122 V19.3.0; the <apiName>may be “aimlec-cp”; the <apiVersion>may be “v1”.

FIG. 5 illustrates an example of a URI structure for the

Aimlec_AIMLEClientParticipation API of a custom operation in accordance with aspects of the present disclosure. The operations supported by the API include the participation in AIML of one or more UE 104, and the custom URI may be a “/participation” URI as seen in FIG. 5.

The response 215 of the second implementation may support the same data structures as discussed above with respect to the first implementation. For example, the response 215 of a custom operation may comprise a response code selected from at least 200 (success), 307 (temporary redirection) or 308 (permanent redirection).

As in the first implementation, in the second implementation, data types of the Aimlec_AIMLEClientParticipation API may include one or more of the following data types: AimlecParticipationReq, which represents the participation request for the AIML operations; AimlecParticipationResp, which represents the participation response for the AIML operations, AimlOper, which represents the participation type, and ClienSetPart, which represents the participation request for the AIMLE client set. In some implementations, data types may re-used in the second implementation as discussed above with respect to the first implementation.

Structured data types of the request 205 and response 215 of the second implementation may be the same as those discussed above with the first implementation. For example, a request 205 of the second implementation may use the same data types identified in FIG. 4. For each operation of the request 205 which the UE 104 is requested to join or depart, the request 205 may also identify the AIML operation (e.g., by an aimOperId attribute) and a schedule of the AIML operation (e.g., aimlOperSched).

The response 215 may include a Boolean indicator indicating the willingness of the UE 104 to comply with the request 205 as discussed above, and errors may be handled in the same manner as the first implementation discussed above.

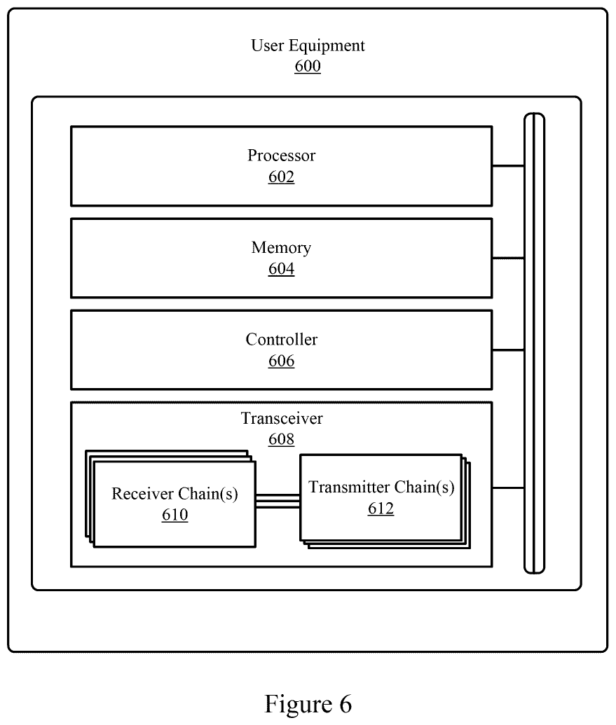

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for AIMLE client participation.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receiving the signal over the air or wireless medium. The receiver chain 610 may include at least one amplifier (e.g., a low-noise amplifier (LNA)) configured to amplify the received signal. The receiver chain 610 may include at least one demodulator configured to demodulate the received signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

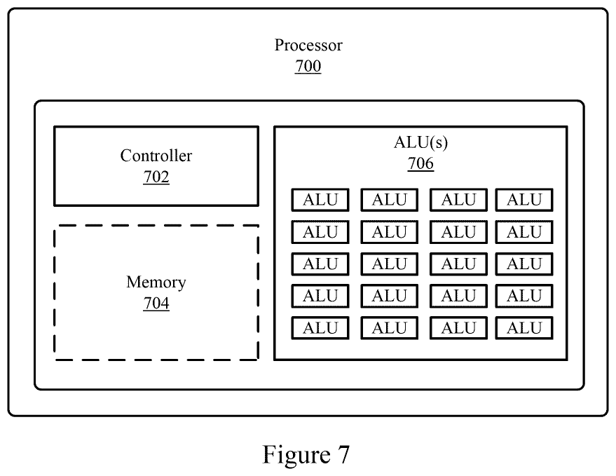

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive -OR(XOR), not -OR(NOR), and not -AND(NAND), enabling the one or more ALUs 706 to handle conditional operations, comparisons, and bitwise operations.

The processor 700 may support wireless communication in accordance with examples as disclosed herein. The processor 700 may be configured to or operable to support a means for AIMLE client participation.

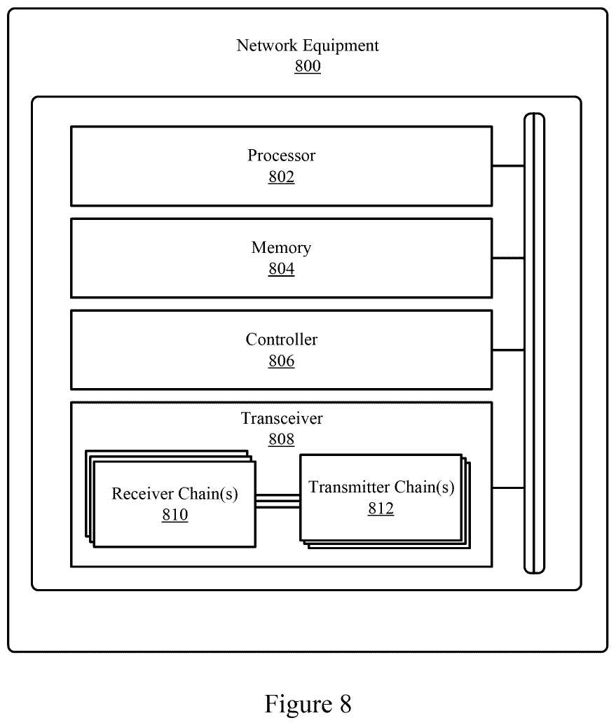

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for soliciting AIMLE client participation.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or a wireless medium. The receiver chain 810 may include at least one amplifier (e.g., a low-noise amplifier (LNA)) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

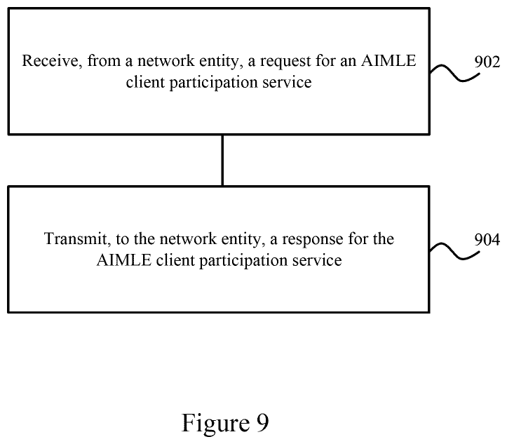

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include receiving, from a network entity, a request for an AIMLE client participation service. The operations of 902 may be performed in accordance with examples as described herein. In some implementations, aspects of the operations of 902 may be performed by a UE as described with reference to FIG. 6.

At 904, the method may include transmitting, to the network entity, a response for the AIMLE client participation service. The operations of 904 may be performed in accordance with examples as described herein. In some implementations, aspects of the operations of 904 may be performed by a UE as described with reference to FIG. 6.

It should be noted that the method described herein describes a possible implementation, and that the operations and the steps may be rearranged or otherwise modified and that other implementations are possible.

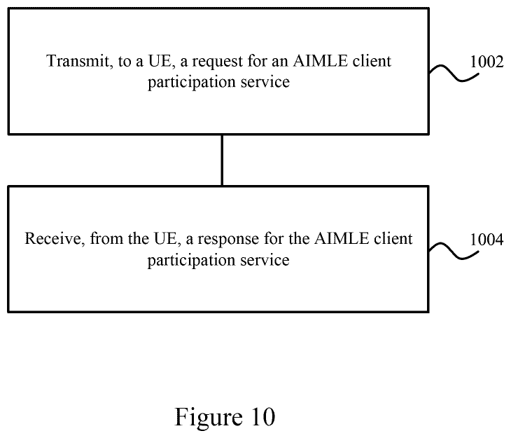

FIG. 10 illustrates a flowchart of a method in accordance with aspects of the present disclosure. The operations of the method may be implemented by a NE as described herein. In some implementations, the NE may execute a set of instructions to control the function elements of the NE to perform the described functions.

At 1002, the method may include transmitting, to a UE, a request for an AIMLE client participation service. The operations of 1002 may be performed in accordance with examples as described herein. In some implementations, aspects of the operations of 1002 may be performed by a NE as described with reference to FIG. 8.

At 1004, the method may include receiving, from the UE, a response for the AIMLE client participation service. The operations of 1004 may be performed in accordance with examples as described herein. In some implementations, aspects of the operations of 1004 may be performed by a NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories; and
one or more processors coupled with the one or more memories and individually or collectively configured to cause the UE to:
receive, from a network entity, a request for an Artificial Intelligence Machine Learning Enablement (AIMLE) client participation service, wherein the request comprises a first format or a second format, wherein the first format comprises a Notification associated with a subscription event comprising information for the AIMLE client participation service, and wherein the second format comprises custom request comprising information for the AIMLE client participation service, and wherein the request comprises an indication for the UE to verify participation in one or more AI/ML operations associated with the AIMLE client participation service; and
transmit, to the network entity, a response for the AIMLE client participation service, wherein the response includes a positive acknowledgment or a negative acknowledgment for the participation in the one or more AI/ML operations associated with the AIMLE client participation service.

2. The UE of claim 1, wherein the request is a notification associated with a subscription event for Service Enabler Architecture Layer (SEAL) group management.

3. The UE of claim 2, wherein the one or more processors are further individually or collectively configured to cause the UE to:
after transmitting the response including the positive acknowledgement, receive announcements for the subscription event from the network entity.

4. The UE of claim 3, wherein the notification includes a Uniform Resource Identifier (URI) comprising information for the AIMLE client participation service associated with the subscription event.

5. The UE of claim 4, wherein the information for the AIMLE client participation service includes at least one operation, at least one schedule, and an indication for adding or removing the UE from a client set.

6. The UE of claim 5, wherein the information for the AIMLE client participation service further comprises at least one dataset requirement for the at least one operation, an identifier of the network entity, an identifier for the AIMLE client set, an identifier of a machine learning (ML) model associated with the at least one operation, and at least one service requirement of the client participation service.

7. The UE of claim 5, wherein the at least one operation is a subset of a set of operations associated with the AIMLE client participation service.

8. The UE of claim 1, wherein the network entity is an AIMLE server.

9. The UE of claim 1, wherein the request is a Hypertext Transfer Protocol (HTTP) request.

10. The UE of claim 9, wherein the HTTP request is an HTTP POST request.

11. A method performed by a user equipment (UE), the method comprising:
receiving, from a network entity, a request for an Artificial Intelligence Machine Learning Enablement (AIMLE) client participation service, wherein the request comprises a first format or a second format, wherein the first format comprises a Notification associated with a subscription event comprising information for the AIMLE client participation service, and wherein the second format comprises a custom request comprising information for the AIMLE client participation service, and wherein the request comprises an indication for the UE to verify participation in one or more AI/ML operations associated with the AIMLE client participation service; and
transmitting, to the network entity, a response for the AIMLE client participation service, wherein the response includes a positive acknowledgment or a negative acknowledgment for the participation in the one or more AI/ML operations associated with the AIMLE client participation service.

12. The method of claim 11, wherein the request is a notification associated with a subscription event for Service Enabler Architecture Layer (SEAL) group management.

13. The method of claim 12, further comprising, after transmitting the response including the positive acknowledgement:
receiving announcements for the subscription event from the network entity.

14. The method of claim 13, wherein the notification includes a Uniform Resource Identifier (URI) comprising information for the AIMLE client participation service associated with the subscription event.

15. The method of claim 14, wherein the information for the AIMLE client participation service includes the at least one operation, the at least one schedule, and the indication for adding or removing the UE from the client set.

16. The method of claim 11, wherein the network entity is an AIMLE server.

17. The method of claim 11, wherein the at least one operation is a subset of a set of operations associated with the AIMLE client participation service.

18. The method of claim 11, wherein request is a Hypertext Transfer Protocol (HTTP) POST request.

19. A network entity for wireless communication, comprising:
one or more memories; and
one or more processors coupled with the one or more memories and individually or collectively configured to cause the network entity to:
transmit, to a user equipment (UE), a request for an Artificial Intelligence Machine Learning Enablement (AIMLE) client participation service, wherein the request comprises a first format or a second format, wherein the first format comprises a Notification associated with a subscription event comprising information for the AIMLE client participation service, and wherein the second format comprises custom request comprising information for the AIMLE client participation service, and wherein the request comprises an indication for the UE to verify participation in one or more AI/ML operations associated with the AIMLE client participation service; and
receive, from the UE, a response for the AIMLE client participation service, wherein the response includes a positive acknowledgment or a negative acknowledgment for the participation in the one or more AI/ML operations associated with the AIMLE client participation service.

20. The network entity of claim 19, wherein the request is a notification associated with a subscription event for Service Enabler Architecture Layer (SEAL) group management, and
wherein the notification includes a Uniform Resource Identifier (URI) comprising information for the AIMLE client participation service associated with the subscription event.
